(19) United States
(12) Patent Application Publication
(10) Pub. No.: US 2016/0252954 A1
(43) Pub. Date: Sep. 1, 2016

(54) CONTROL APPARATUS

(71) Applicant: Microsoft Technology Licensing, LLC, Redmond, WA (US)

(72) Inventor: Apaar Tuli, Helsinki (FI)

(21) Appl. No.: 14/633,447

(22) Filed: Feb. 27, 2015

(51) Int. Cl. G06F 3/01; G09G 5/12; G06F 3/14

(52) U.S. Cl. CPC G06F 3/01; G06F 3/1454; G09G 5/12; G09G 2370/16; G09G 2354/00

(57) ABSTRACT

An apparatus for controlling a graphical user interface of a device is disclosed. The apparatus comprises at least one processing unit, at least one memory storing pairing information for at least two devices, a wireless transceiver enabling a local wireless connection with the at least two devices paired with the apparatus and a button enabling launching of an application. When the apparatus detects a press of a button, it accesses state information relating to the at least two devices. A signal is sent, based on the state information, to at least one of the at least two devices with the wireless transceiver to launch the application in response to detecting the press of the button.

### BACKGROUND

An apparatus, for example, a pen or a stylus may be used to control a device, for example, a smart phone or a tablet computer. A user may also input data via a touch-sensitive screen of the device using the pen or stylus.

### SUMMARY

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

An apparatus comprises at least one processing unit, at least one memory storing pairing information for at least two devices, a wireless transceiver enabling a local wireless connection with the at least two devices paired with the apparatus and a button enabling launching of an application. The at least one memory stores program instructions that, when executed by the at least one processing unit, cause the apparatus to detect a press of the button, access state information relating to the at least two devices, and send, based on the state information, a signal to at least one of the at least two devices with the wireless transceiver to launch the application in response to detecting the press of the button.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a block diagram of an apparatus that can be used to interact with multiple devices having a graphical user interface.

FIG. 2A illustrates an example where a pen can be used with two different devices and the pen is currently connected only to one device.

FIG. 2B illustrates an example where a pen can be used with two different devices and the pen is currently connected to both devices.

FIG. 2C illustrates another example where a pen can be used with two different devices and the pen is currently connected to both devices.

FIG. 2D illustrates another example where a pen can be used with two different devices and the pen is currently connected to both devices.

FIG. 2E illustrates another example where a pen can be used with two different devices and the pen is currently connected to both devices.

FIG. 2F illustrates another example where a pen can be used with two different devices and the pen is currently connected to both devices.

FIG. 2G illustrates another example where a pen can be used with two different devices and the pen is currently connected to both devices.

FIG. 2H illustrates another example where a pen can be used with two different devices and the pen is currently connected to both devices.

FIG. 3A illustrates another example where a pen can be used with two different devices and the pen is currently connected to both devices.

FIG. 3B illustrates another example where a pen can be used with two different devices and the pen is currently connected to both devices.

FIG. 4 illustrates a block diagram of an apparatus that can be used to interact with a pen.

FIG. 5 illustrates another example where a pen can be used with two different devices and the pen is currently connected to both devices.

FIG. 6 illustrates another example where a pen can be used with two different devices.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

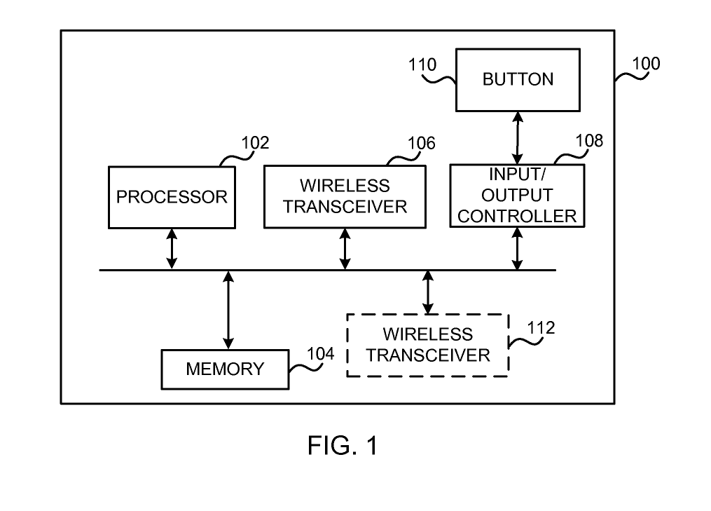

FIG. 1 illustrates a block diagram of a control apparatus that can be used to interact with multiple devices having a graphical user interface. The devices may include, for example, a smart phone, a tablet computer, a laptop computer, a display device etc.

The control apparatus 100, for example, a pen or stylus, comprises one or more processors 102 which may be microprocessors, controllers or any other suitable type of processors or processing units for processing computer executable instructions to control the operation of the pen 100. Computer executable instructions may be provided using any computer-readable media that is accessible by the pen 100. Computer-readable media may include, for example, computer storage media such as a memory or memories 104 and communications media. Computer storage media, such as the memory 104, includes volatile and non-volatile, removable and non-removable media implemented in any method or technology for storage of information such as computer readable instructions, data structures, program modules or other data. Computer storage media may include, but is not limited to, Random Access Memory (RAM), Read-Only Memory (ROM), Erasable Programmable Read-Only Memory (EPROM), Electronically Erasable Programmable Read-Only Memory (EEPROM), flash memory or other memory technology.

The pen 100 may comprise an input/output controller 108 configured to receive a signal or signals from a button 110. When the button 110 is pressed by a user, the input/output controller 108 receives the signal or signals and conveys the signal to the processor 102 via an information bus.

The pen 100 comprises also a wireless transceiver 106 which enables establishing a wireless connection with one more other devices. The wireless transceiver refers, for example, to a short-range wireless transceiver implemented using any appropriate wireless technology providing a local connectivity. The wireless technologies comprise, for example, Bluetooth™, Wi-Fi, ZigBee or any other short-range or local wireless technique. Optionally, the pen 100 may also comprise a second wireless transceiver 112 for mobile communication network access so that the pen 100 is able to have a data connection to a network entity, for example a network server, for example, via the internet. The second wireless transceiver 112 may provide access to any mobile communication network, for example, a WCDMA (Wideband Code Division Multiple Access) network, an LTE (Long Term Evolution) network, a 4G LTE network etc.

When establishing a wireless connection for the first time between the pen 100 and another device, a pairing process may be performed. The memory 104 may store information relating to the pairing and paired devices. Although FIG. 1 illustrates only a single memory 104, in another example, the pen may comprise multiple memories, and a memory may be an integral part of the processor 102.

The processor 102 may be configured to detect a button press, access state information relating to the first device and the second device, and send, based on the state information of the first device and the second device, a signal to at least one of the first device and the second device with the wireless transceiver to launch the application in response to detecting the button press.

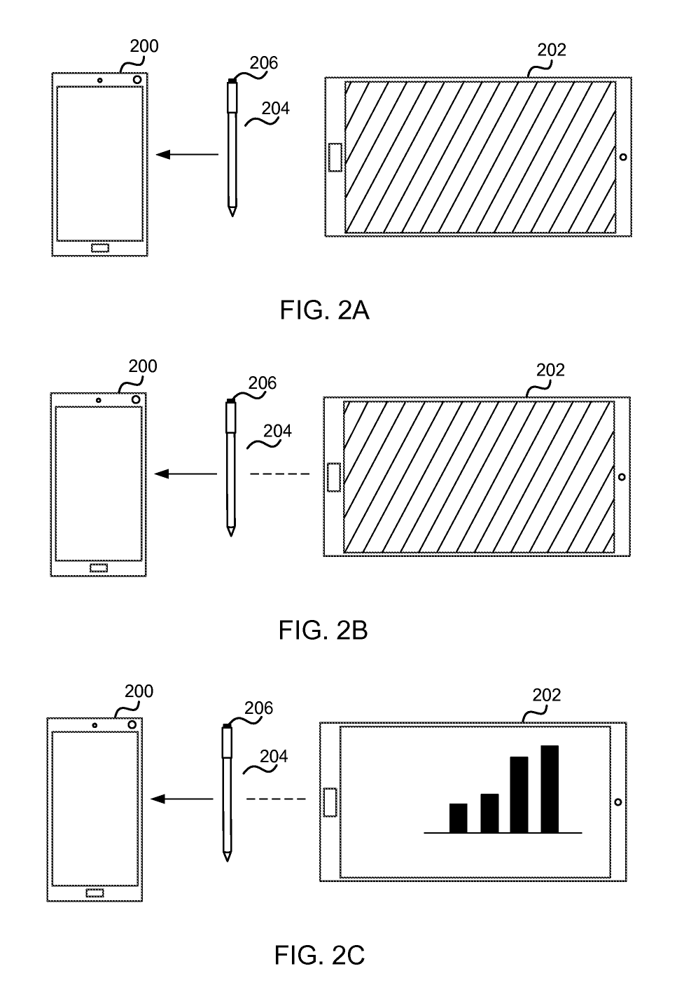

FIG. 2A illustrates an example where a pen 204 can be used with two different devices and the pen currently connected only to one device. The example includes a first device 200 and a second device 202. The first device 200 is, for example, a smart phone and the second device 202 is, for example, a tablet computer. A user is able to use the pen both with the first device 200 and the second device 202. The pen 204 has been paired with both devices. Information relating to the devices and pairing may be stored in an internal memory of the pen 204. However, the pen 204 is connected only to one device, namely, the first device 200. The user of the pen 204 then presses a button 206 of the pen 204. The press indicates that the user wishes to launch an application, for example, a word processing application or a drawing application. The user may be able to determine, either by configuring the pen or the first device, which application is launched when the button is pressed.

The pen 204 determines with which device the application is to be launched. Since only the first device 200 is connected to the pen 204, the pen 204 sends a signal to the first device 200 to launch the application.

FIG. 2B illustrates an example where a pen can be used with two different devices and the pen is currently connected to both devices.

In the example of FIG. 2B, the pen 204 is currently connected to both the first device 200 and the second device 202. The pen 204 is able to determine that the second device 202 is turned on and connected to the pen 204 but its screen is turned off Since the first device 200 is also connected to the pen 204 and its screen is turned on, the pen 204 sends a signal to the first device 200 to launch the application.

In one example, the pen 204 may send a query to the devices about their status when the pen 204 detects that the user presses the button 206. Based on the responses to the queries from the devices, the pen 204 determines that the screen of the first device 200 is turned on and the screen of the second device 202 is turned off. In another example, the pen 204 may send periodic queries to the devices and store status data relating to the devices in a memory. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204.

FIG. 2C illustrates another example where a pen can be used with two different devices and the pen is currently connected to both devices.

In the example of FIG. 2C, the pen 204 is currently connected to both the first device 200 and the second device 202. The pen 204 is able to determine that the second device 204 is being used to present information using another application, for example, playing a video clip or showing a presentation. Since the first device 200 is also connected to the pen 204, the pen 204 sends a signal to the first device 200 to launch the application.

In one example, the pen 204 may send a query to the devices about their status when the pen 204 detects that the user presses the button 206. Based on the responses to the queries from the devices, the pen 204 determines that the screen of the first device 200 is available to be used and that the second device 204 is being used to display data relating to another application. In another example, the pen 204 may send periodic queries to the devices and store status data relating to the devices in a memory. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204.

FIG. 2D illustrates another example where a pen 204 can be used with two different devices and the pen 204 is currently connected to both devices.

In the example of FIG. 2D, the pen 204 is currently connected to both the first device 200 and the second device 202. The pen 204 is able to determine which of the devices is closer 208 to the pen 204. The determination may be made, for example, based on wireless signals (for example, Bluetooth™ signals) between the pen 204 and the devices. In this example, the pen 204 determines that the first device 200 is closer to the pen 204 than the second device 202. Therefore, the pen 204 sends a signal to the first device 200 to launch the application.

In one example, the pen 204 determines periodically the distance to the devices and may store the results in a memory. When the pen 204 detects that the user presses the button 206, the proximity determination may be made based on the data stored in the memory. In another example, the pen 204 makes the proximity determination only when the user presses the button 206.

FIG. 2E illustrates another example where a pen 204 can be used with two different devices and the pen 204 is currently connected to both devices.

In the example of FIG. 2E, the pen 204 is currently connected to both the first device 200 and the second device 202. The pen 204 is able to determine that the second device 202 is turned on and that a user is currently holding the first device 200 in his hand. The first device 200 may use any grip detection technology using at least one sensor in the device 200 to determine that the user is currently holding the first device 200 in his hand. Thus, the pen 204 could instruct either of the devices to launch the application when the user presses the button 206. However, since the user holds the first device 200 in his hand, the pen 204 deduces that the user is presently using the first device 200. Therefore, the pen 204 sends a signal to the first device 200 to launch the application.

In one example, the pen 204 may send a query to the devices about their status when the pen 204 detects that the user presses the button 206. Based on the responses to the queries from the devices, the pen 204 determines that both devices are connected to the pen 204. The pen 204 also learns that the user holds the first device 200 in his hand. In another example, the pen 204 may send periodic queries to the devices and store status data relating to the devices in a memory. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204. When the user presses the button 206, the pen 204 checks the status data in the memory and makes the determination to which device the signal to launch the application is sent.

FIG. 2F illustrates another example where a pen 204 can be used with two different devices and the pen 204 is currently connected to both devices.

In the example of FIG. 2F, the pen 204 is currently connected to both the first device 200 and the second device 202. The pen 204 is able to determine that the first device 200 is in a pocket or a handbag, for example, based on proximity sensor data from the first device 200. Therefore, when the user presses the button 206, the pen 204 sends a signal to the second device 202 to launch the application.

In one example, the pen 204 may send a query to the devices about their status when the pen 204 detects that the user presses the button 206. Based on the responses to the queries from the devices, the pen 204 determines that both devices are connected to the pen 204. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204. The pen 204 also learns that the proximity sensor data from the first device indicates that the first device 200 is in a pocket or a handbag. In another example, the pen 204 may send periodic queries to the devices and store status data relating to the devices in a memory. When the user presses the button 206, the pen 204 checks the status data in the memory and makes the determination to which device the signal to launch the application is sent based on the status data.

FIG. 2G illustrates another example where a pen 204 can be used with two different devices and the pen 204 is currently connected to both devices.

In the example of FIG. 2G, the pen 204 is currently connected to both the first device 200 and the second device 202. The pen 204 is able to determine that the screen of the first device 200 is facing down. Therefore, when the user presses the button 206, the pen 204 sends a signal to the second device 202 to launch the application.

In one example, the pen 204 may send a query to the devices about their status when the pen 204 detects that the user presses the button 206. Based on the responses to the queries from the devices, the pen 204 determines that both devices are connected to the pen 204. The pen 204 also learns from the data received from the first device 200 that the screen of the first device 200 is facing down. In another example, the pen 204 may send periodic queries to the devices and store status data relating to the devices in a memory. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204. When the user presses the button 206, the pen 204 checks the status data in the memory and makes the determination to which device the signal to launch the application is sent based on the status data.

FIG. 2H illustrates an example where a pen can be used with two different devices and the pen is currently connected to both devices.

In the example of FIG. 2H, the pen 204 is currently connected to both the first device 200 and the second device 202. The pen 204 is able to determine that the second device 202 is turned on and connected to the pen 204 but its screen is covered by a screen cover 210. Since the first device 200 is also connected to the pen 204 and its screen is not covered, the pen 204 sends a signal to the first device 200 to launch the application.

In one example, the pen 204 may send a query to the devices about their status when the pen 204 detects that the user presses the button 206. Based on the responses to the queries from the devices, the pen 204 determines that the screen cover 210 is covering the screen of the second device 202. In another example, the pen 204 may send periodic queries to the devices and store status data relating to the devices in a memory. In another example, the pen 204 may receive status updates from the devices without sending any queries. For example, the second device 202 may again turn on its screen. This change in the state of the second device 202 causes a status update message to be sent to the pen 204. Thus, when the pen 204 need not poll the devices periodically, it also saves the battery of the pen 204 When the user presses the button 206, the pen 204 checks the status data in the memory and makes the determination to which device the signal to launch the application is sent based on the status data.

The examples disclosed above described that the pen may receive and store state information relating to the devices or that the pen may request state information from the devices. The state information may refer to any piece of information that reflects the current operational state of the devices. In another example, state information relating to the devices may be stored in an entity other than the pen and the device, for example, in a cloud service. The pen may connect to the cloud service directly using, for example, a WiFi connection or a mobile communication network connection provided by a wireless transceiver included in the pen enabling mobile communication network access. Alternatively, the connection to the cloud service may be established via another device over a Bluetooth or WiFi connection. Further, in another example, the pen may receive state information updates relating to the devices from a network entity, for example, a network server or a cloud service. Thus, the pen may comprise a wireless transceiver for a mobile communication network so that the pen may have a direct connection to the network entity with the mobile communication network module. In other words, the devices may send state information updates to the network entity, and the network entity sends the updates to the pen and the pen stores the updates. Thus the pen need not separately request the state information updates from the network server. Alternatively, the network entity may request state information from the devices. The network entity may also store the state information received from the devices.

FIGS. 2A-2H illustrate various examples showing how the pen may determine to which device the signal to launch the application is sent. It is evident that also other parameters not disclosed by these examples may be used as parameters for selecting the device to launch the application. These other parameters comprise, for example, one or more of the following:
battery status (the device having more power is selected)
screen size (the device having larger screen is selected)
last used device (the device that was last used with the pen or the device being primarily used with the pen is selected)
front camera data (the device whose front camera detects the user's face or other motion activity is selected)
data from a fingerprint sensor (launching the application with a device where the user's finger in placed on the fingerprint reader)
iris/retina scanner data (launching the application with a device detecting the user's eye).

The examples disclosed in any of FIGS. 2A-2H enable a solution where a control apparatus, for example, a pen, can be used to launch an application using a desired device. When the devices behave according to the user's expectations, this leads to a positive user experience. Further, it may be possible for the user to select priorities for various status parameters. For example, if the screen size status parameter has the highest priority then, in a situation when multiple devices are connected to the pen, a device having the largest screen size is always automatically used to launch the application. Or, as another example, if the user has selected that the proximity of a device to the pen has the highest priority, then the application is always launched on an active device being closest to the pen. Further, since there may be set a certain priority for the status parameters, power is saved by not unnecessarily turning, for example, the device screens on. As screens get bigger and processors need to be woken up to drive the screens, it becomes important to save the battery by avoiding unnecessary wakeups of the screen.

Although the examples disclosed in any of FIGS. 2A-2H described two devices, the pen may be shared with more than two devices. For example, a pen belonging to a certain user can be used to trigger actions on any number of devices, allowing writing, for example, on guest devices and shared devices too.

In a further example, if it cannot be determined, based on a single status parameter, which device to use to launch the application, one or more additional status parameters may be used. If two devices are connected to the pen, and both devices have an active connection with the pen, the pen may not yet be able to select the device to which the signal to launch the application is sent. The device may use a further parameter for the selection. For example, the signal may be sent to an active device having a larger screen size.

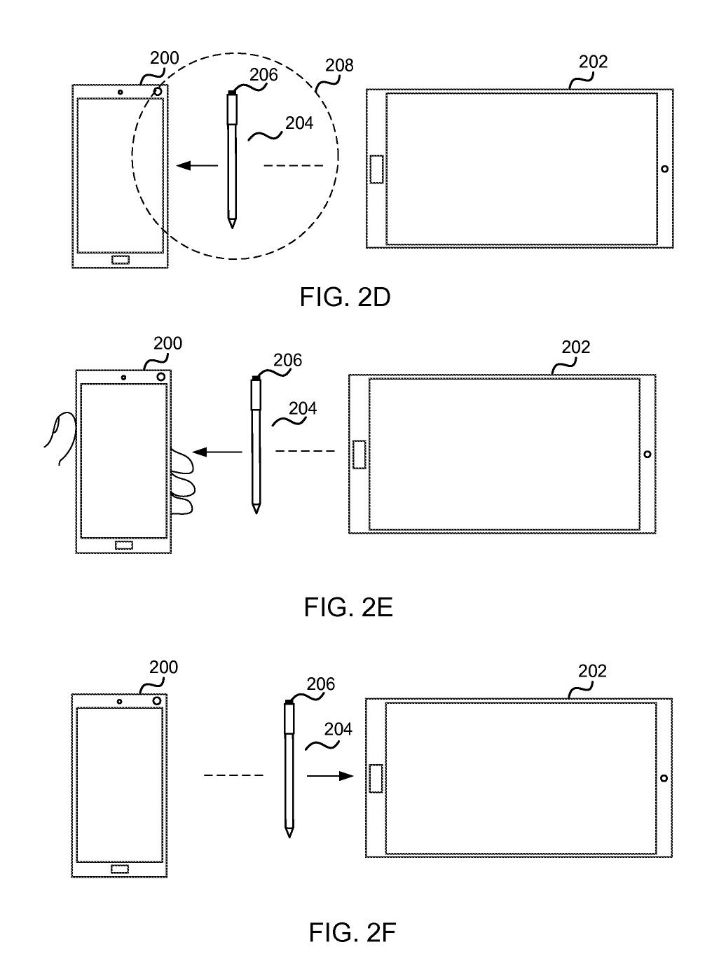

FIGS. 3A and 3B illustrate another example where a pen can be used with two different devices and the pen is currently connected to both devices. The example includes a first device 300 and a second device 302. The first device 300 is, for example, a smart phone and the second device 302 is, for example, a tablet computer. A user is able to use the pen 304 both with the first device 300 and the second device 302. The pen 304 has been paired with both devices. Information relating to the devices and pairing may be stored in an internal memory of the pen 304. A user of the pen 304 then presses a button 306 of the pen 304. The press indicates that the user wishes to launch an application, for example, a word processing application or a drawing application. The user may be able to determine, either by configuring the pen or the devices, which application is launched when the button is pressed.

If both the first device 300 and the second device 302 are connected to the pen 304, the pen 304 may not be able to determine with which device to launch the application. Instead, the pen 304 broadcasts a signal to all currently connected devices (the first device 300 and the second device 302 in this example) to launch the application. In response to the broadcast signal, both devices launch the application.

Both the first device 300 and the second device 302 thus launch the application in response to receiving the broadcast signal, as indicated in FIG. 3A. As illustrated in FIG. 3B, the user starts using one of the devices with the pen 304 (for example, the second device 302). The second device 302 may be configured to send a signal 308 to the first device 302 indicating that the user started using (for example, when the user starts making a note on the screen with the pen 304) the second device 302. In response to the signal 308, the first device 300 may close the launched application. It may also return back to a state before the application was launched.

When the application is automatically closed in the first device 300, a smooth user experience is provided, battery life is conserved and accidental input on the active touch area on the screen is reduced and thus unexpected surprises are avoided.

The communication between the first device 300 and the second device 302 may be implemented, for example, using any of the following alternatives: device to device signaling, device to device signaling via the pen 304, adhoc networking, for example, using WiFi direct or Bluetooth, or signaling via a cloud service (for example, different devices belonging to the same user may exchange data using the user's cloud service credentials).

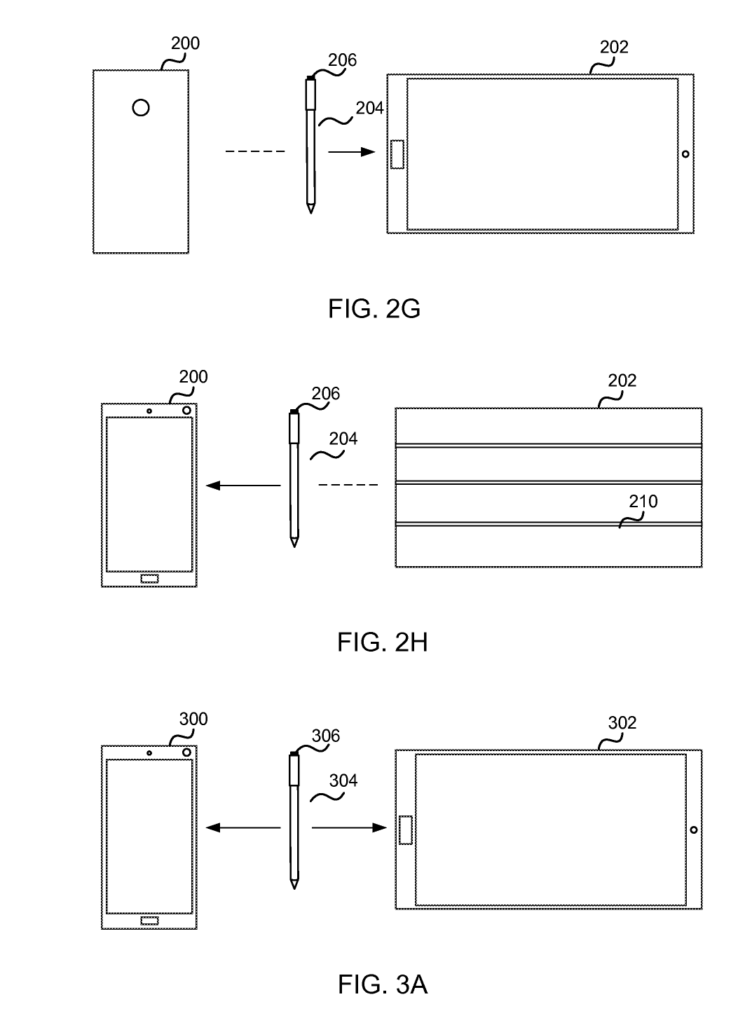

FIG. 4 illustrates a block diagram of an apparatus that can be used to interact with a pen. The apparatus 400 may be a smart phone, a tablet computer, a laptop computer, a display device or any other device having a touch-sensitive display.

The apparatus 400 comprises one or more processors 402 which may be microprocessors, controllers or any other suitable type of processors or processing units for processing computer executable instructions to control the operation of the apparatus 400. Computer executable instructions may be provided using any computer-readable media that is accessible by the apparatus 400. Computer-readable media may include, for example, computer storage media such as a memory or memories 404 and communications media. Computer storage media, such as the memory 404, includes volatile and non-volatile, removable and non-removable media implemented in any method or technology for storage of information such as computer readable instructions, data structures, program modules or other data. Computer storage media may include, but is not limited to, Random Access Memory (RAM), Read-Only Memory (ROM), Erasable Programmable Read-Only Memory (EPROM), Electronically Erasable Programmable Read-Only Memory (EEPROM), flash memory or other memory technology. Further, although FIG. 4 illustrates only a single memory 404, in another example, the apparatus may comprise multiple memories, and a memory may be an integral part of the processor 402.

The apparatus 400 may comprise an input/output controller 408 configured to receive control instruction provided on the touch-sensitive display 410 and to control the touch-sensitive display 410 to display data.

The apparatus 400 comprises also a wireless transceiver 406 which enables establishing a wireless connection with a pen or a stylus and with another device, for example, a smart phone, a tablet computer, a laptop computer, a display device or any other device having a touch-sensitive display. The wireless transceiver refers, for example, to a short-range wireless transceiver implemented using any appropriate wireless technology. The wireless technologies comprise, for example, Bluetooth™, Wi-Fi, ZigBee or any other short-range wireless technique.

When establishing a wireless connection for the first time between the apparatus 400 and the pen and another wireless device, a pairing process may be performed. The memory 404 may store information relating to the pairing and paired devices. In this example, the apparatus 402 has been paired with the pen and another apparatus.

The processor 402 is configured to detect that a broadcast signal is received from the pen with the wireless transceiver 406. The broadcast signal received from the pen instructs the apparatus 400 to launch an application, for example, an application with which a user may take notes using the pen. In response to detecting the broadcast signal, the processor 402 causes launching of the application with the apparatus 400. If the processor 402 detects, based on information received from the input/output controller 408, that the user starts using the application with the apparatus 400, the processor 402 may cause a signal to be sent to the other apparatus paired with the apparatus 400. The signal indicates to the other apparatus that the user has started using the application with the apparatus 400.

Earlier, also the other apparatus (for example, a smart phone 300) received the broadcast signal and launched the same application than the apparatus 400. Now, when the other apparatus receives the signal from the apparatus 400, it may close the launched application since the user did not start using the application with that apparatus. On the other hand, if the apparatus 400 receives a signal from another device (for example, the smart phone 300) and the signal indicates that the user started using the launched application with the smart phone 300, the apparatus 400 may close the launched application since the user did not start using the application with the apparatus 400.

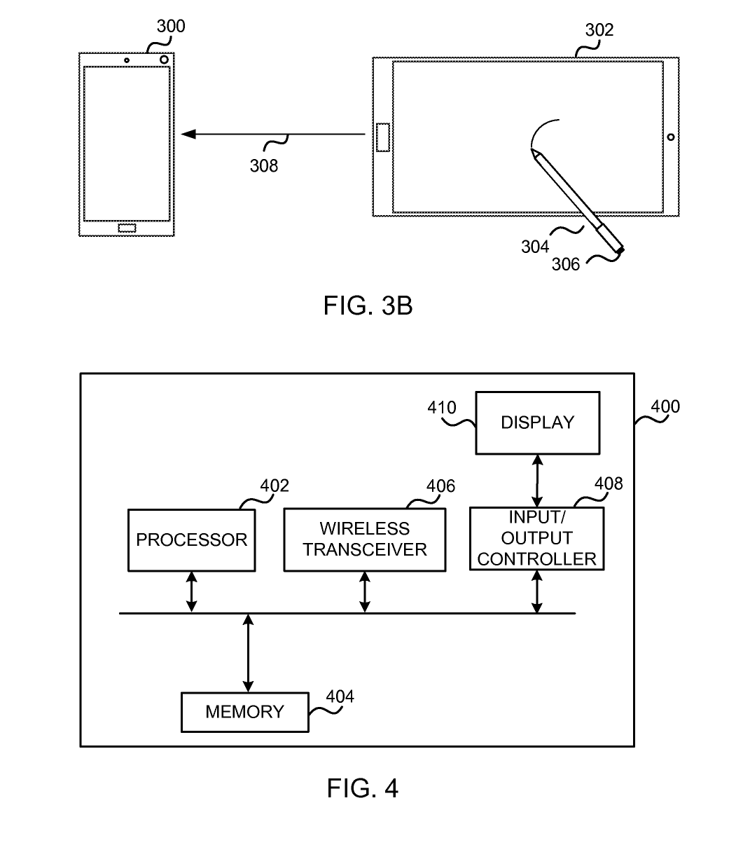

FIG. 5 illustrates another example where a pen can be used with two different devices and the pen is currently connected to both devices. The example includes a first device 500 and a second device 502. The first device 500 is, for example, a smart phone and the second device 502 is, for example, a tablet computer. A user is able to use the pen 504 both with the first device 500 and the second device 502. The pen 504 has been paired with both devices. A network server 510 may comprise a memory or memories storing a state information database 512 or may have a connection to an external memory comprising the state information database. In one example, the network server 510 runs a cloud service to which the pen 504 is able to connect to. The pen 504 may connect to the cloud service directly using, for example, a WiFi connection or a mobile communication network connection provided by a mobile communication network module included in the pen 504. Alternatively, the connection from the pen 504 to the cloud service may be established via another device over a Bluetooth or WiFi connection.

The state information database 512 may store status data relating to the first device 500 and the second device 502. The status data may include one or more of the following pieces of data for each device:
wireless connectivity state between the device and the pen
presentation mode state of the device;
screen state of the device;
battery state of the device;
screen orientation state of the device;
proximity sensor state from the device;
display size of the device;
camera detection state from the device;
screen cover state of the device;
grip detection state of the device; and
proximity of the device to the pen;
data from a fingerprint sensor (launching the application with a device where the user's finger in placed on the fingerprint reader); and
iris or retina scanner data (launching the application with a device detecting the user's eye).

When the user of the pen 504 then presses a button 506 of the pen 504, the pen 504 sends a signal 508 to the network server 510, the signal 508 indicating that the button 506 has been pressed. The network server 510 may determine, based on the information stored in the state information database 512, to send a signal 514, 516 to launch an application in both devices 500, 502. As already illustrated in FIG. 3B, the user starts using one of the devices with the pen 504 (for example, the second device 502). The second device 502 may be configured to send a signal 518 to the first device 502 indicating that the user started using (for example, starts making a note on the screen with the pen 504) the second device 502. In response to the signal 518, the first device 500 may close the launched application. It may also return back to a state before the application was launched.

Alternatively, the network server 510 may determine, based on the information stored in the state information database 512, to send only a signal 514 or 516, in other words, only to the first device 500 or to the second device 502 to launch the application. Examples of the determination logic were given in FIGS. 2A-2H and their description, and the network server 510 may use similar logic here. As a summary of the various alternatives disclosed in relation to FIGS. 2A-2H, the state information database may comprise several status parameters relating to the first device 500 and the second device 502. Each status parameter may be associated with a parameter value. Each parameter may also have priority values. A device status parameter may have a higher priority value than another device status parameter. If priority values are used, the network server 510 may choose a device which has a status parameter having a higher priority value. If both devices have the same status parameter having the same priority value, the parameter value may be used to determine the device to be chosen. For example, the wireless connectivity state between the device and the pen may have the highest priority value, since the wireless connectivity state determines whether the pen is currently connected to a device or not. If both devices are connected to the pen, the network server 510 may use a secondary status parameter to determine the device to be chosen.

The network server 510 may comprise one or more processors which may be microprocessors, controllers or any other suitable type of processors or processing units for processing computer executable instructions to control the operation of the network server. Computer executable instructions may be provided using any computer-readable media that is accessible by the network server. Computer-readable media may include, for example, computer storage media such as a memory and communications media. Computer storage media, such as the memory, includes volatile and non-volatile, removable and non-removable media implemented in any method or technology for storage of information such as computer readable instructions, data structures, program modules or other data. Computer storage media may include, but is not limited to, Random Access Memory (RAM), Read-Only Memory (ROM), Erasable Programmable Read-Only Memory (EPROM), Electronically Erasable Programmable Read-Only Memory (EEPROM), flash memory or other memory technology. The network server may comprise also multiple memories, and a memory may be an integral part of the processor.

The network server 510 comprises also a network interface which enables establishing a data connection via a data communication network with at least one device, for example, a smart phone, a tablet computer, a laptop computer, a pen, a stylus or a display device or any other device having a touch-sensitive display.

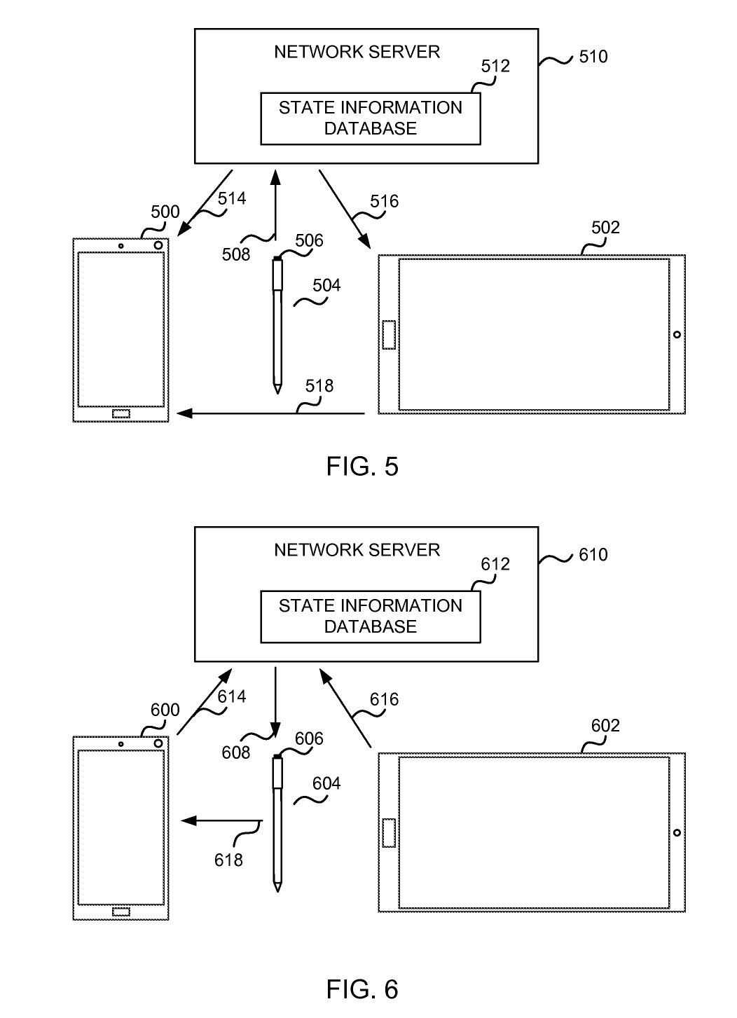

FIG. 6 illustrates another example where a pen 604 can be used with two different devices. The example includes a first device 600 and a second device 602. The first device 600 is, for example, a smart phone and the second device 602 is, for example, a tablet computer. A user is able to use the pen 604 both with the first device 600 and the second device 602. The pen 604 comprises a wireless transceiver for establishing a location wireless connection with the devices and has been paired with both devices. A network server 610 may comprise a memory or memories storing a state information database 612 or may have a connection to an external memory comprising the state information database. In one example, the network server 610 runs a cloud service to which the pen 604 is able to connect to. The pen 604 may connect to the cloud service directly using, for example, a WiFi connection or a mobile communication network connection provided by a mobile communication network module included in the pen 604. Alternatively, the connection from the pen 604 to the cloud service may be established via another device over a Bluetooth or WiFi connection.

The state information database 612 may store status data relating to the first device 600 and the second device 602. The status data may include one or more of the following pieces of data for each device:
wireless connectivity state between the device and the pen
presentation mode state of the device;
screen state of the device;
battery state of the device;
screen orientation state of the device;
proximity sensor state from the device;
display size of the device;
camera detection state from the device;
screen cover state of the device;
grip detection state of the device; and
proximity of the device to the pen;
data from a fingerprint sensor (launching the application with a device where the user's finger in placed on the fingerprint reader); and
iris or retina scanner data (launching the application with a device detecting the user's eye).

The first device 600 and the second device 602 may send state updates 614, 616 to the network server 610. Alternatively, the network server 610 may request state updates from the first device 600 and the second device 602. The network server 610 keeps the pen 604 updated on the status of the first device 600 and the second device 602 by sending status updates 608 to the pen 604. Thus, the pen 604 stores the same information that is stored in the state information database 612. When the user of the pen 604 then presses a button 606 of the pen 604, the pen 604 accesses the state information relating to the first device 600 and the second device 602. The pen 604 may determine, based on the information stored in the state information, to send only a signal 618 to the first device 600 to launch an application. Examples of the determination logic were given in FIGS. 2A-2H and their description, and the pen 604 may use similar logic here. As a summary of the various alternatives disclosed in relation to FIGS. 2A-2H, the state information may comprise several status parameters relating to the first device 600 and the second device 602. Each status parameter may be associated with a parameter value. Each parameter may also have priority values. A device status parameter may have a higher priority value than another device status parameter. If priority values are used, the pen 604 may choose a device which has a status parameter having a higher priority value. If both devices have the same status parameter having the same priority value, the parameter value may be used to determine the device to be chosen. For example, the wireless connectivity state between the device and the pen may have the highest priority value, since the wireless connectivity state determines whether the pen is currently connected to a device or not. If both devices are connected to the pen, the pen 604 may use a secondary status parameter to determine the device to be chosen.

Alternatively, the network server 610 may not send status updates 608 to the pen 604. Instead, when the user of the pen 604 presses the button 606 of the pen 604, the pen 604 sends a request to the network server 610 asking with which device the application is to be launched. Thus, the network server 610 determines, based on the information stored in the state information database 612, to which device the pen 604 is to send a signal to launch the application. After the determination, the network server 610 sends a response to the pen 604 indicating the device to which the pen 604 is to a signal to launch the application.

An example of an apparatus comprises at least one processing unit, at least one memory storing pairing information for at least two devices, a wireless transceiver enabling a wireless connection with the at least two devices paired with the apparatus and a button enabling launching of an application. The at least one memory stores program instructions that, when executed by the at least one processing unit, cause the apparatus to detect a press of the button, access state information relating to the at least two devices, and send, based on the state information, a signal to at least one of the at least two devices with the wireless transceiver to launch the application in response to detecting the press of the button.

In one example, the at least one memory storing program instructions that, when executed by the at least one processing unit, cause the apparatus to receive state information relating to the at least two devices from the at least two devices with the wireless transceiver, and store the received state information in the memory

In one example, the at least one memory storing program instructions that, when executed by the at least one processing unit, cause the apparatus to periodically request state information relating to the at least two devices from an entity external to the apparatus, and store the requested state information in the memory.

In one example, the at least one memory storing program instructions that, when executed by the at least one processing unit, cause the apparatus to request state information relating to the at least two devices from an entity external to the apparatus in response to detecting the press of the button.

In one example, the at least one memory storing program instructions that, when executed by the at least one processing unit, cause the apparatus to request state information from the at least two devices in response to detecting the press of the button.

In one example, the apparatus comprises a second wireless transceiver enabling a connection to a network entity, wherein the at least one memory stores program instructions that, when executed by the at least one processing unit, cause the apparatus to receive state information relating to the at least two devices from the network entity with the second wireless transceiver and store the received state information in the memory.

In one example, the apparatus comprises a second wireless transceiver enabling a connection to a network entity, wherein the at least one memory stores program instructions that, when executed by the at least one processing unit, cause the apparatus to request state information relating to the at least two devices from the network entity with the second wireless transceiver in response to detecting the press of the button.

In one example, alternatively or in addition, the state information comprises at least one status parameter for each device, each status parameter having a priority value, the at least one memory storing program instructions that, when executed by the at least one processing unit, cause the apparatus to select a device having a status parameter having the highest priority value in the state information; and send the signal to the selected device.

In one example, alternatively or in addition, the state information for a device comprises information on at least one of the following: wireless connectivity state between the apparatus and the device, presentation mode state of the device, screen state of the device, battery state of the device, screen orientation state of the device, proximity sensor state from the device, display size of the device, camera detection state from the device, screen cover state of the device, grip detection state of the device, and proximity of the device to the apparatus.

In one example, alternatively or in addition, the at least one memory storing program instructions that, when executed by the at least one processing unit, cause the apparatus to determine, based on the wireless connectivity state, that the apparatus is connected only to one device, and send the signal to the connected device.

In one example, alternatively or in addition, the at least one memory storing program instructions that, when executed by the at least one processing unit, cause the apparatus to determine, based on the presentation mode state, whether a device is being used for active presentation, and send the signal to a device not being used for an active presentation.

In one example, alternatively or in addition, the at least one memory storing program instructions that, when executed by the at least one processing unit, cause the apparatus to determine, based on the screen state, whether the screen of a device is off, and send the signal to a device having the screen on.

In one example, alternatively or in addition, the at least one memory storing program instructions that, when executed by the at least one processing unit, cause the apparatus to select, based on the battery state of each device, a device having the highest remaining battery charge level, and send the signal to the selected device.

In one example, alternatively or in addition, the at least one memory storing program instructions that, when executed by the at least one processing unit, cause the apparatus to select, based on the screen orientation state of each device, a device having its screen facing up, and send the signal to the selected device.

In one example, alternatively or in addition, the at least one memory storing program instructions that, when executed by the at least one processing unit, cause the apparatus to select, based on the proximity sensor state of each device, a device having proximity sensor data indicating free space around the device, and send the signal to the selected device.

In one example, alternatively or in addition, the at least one memory storing program instructions that, when executed by the at least one processing unit, cause the apparatus to select, based on the display size of each device, a device having the largest display size, and send the signal to the selected device.

In one example, alternatively or in addition, the at least one memory storing program instructions that, when executed by the at least one processing unit, cause the apparatus to select, based on the camera detection state of each device, a device detecting a user of the device, and send the signal to the selected device.

In one example, alternatively or in addition, the at least one memory storing program instructions that, when executed by the at least one processing unit, cause the apparatus to select, based on the screen cover state of each device, a device not covered by a screen cover, and send the signal to the selected device.

In one example, alternatively or in addition, the at least one memory storing program instructions that, when executed by the at least one processing unit, cause the apparatus to select, based on the grip detection state of each device, a device gripped by a user, and send the signal to the selected device.

In one example, alternatively or in addition, the at least one memory storing program instructions that, when executed by the at least one processing unit, cause the apparatus to select, based on the proximity of each device to the apparatus, a device closest to the apparatus, and send the signal to the selected device.

In an example a pen for controlling a touch-sensitive graphical user interface of a device comprises an apparatus comprising at least one processing unit, at least one memory storing pairing information for at least two devices, a wireless transceiver enabling a wireless connection with the at least two devices paired with the apparatus and a button enabling launching of an application. The at least one memory stores program instructions that, when executed by the at least one processing unit, cause the apparatus to detect a press of the button, access state information relating to the at least two devices, and send, based on the state information, a signal to at least one of the at least two devices with the wireless transceiver to launch the application in response to detecting the press of the button.

In an example an apparatus comprises at least one processing unit, at least one memory storing pairing information for at least two devices, a first wireless transceiver enabling a local wireless connection with the at least two devices paired with the apparatus, a second wireless transceiver enabling a connection to a network entity, and a button enabling launching of an application. The at least one memory stores program instructions that, when executed by the at least one processing unit, cause the apparatus to detect a press of the button, and send a signal to the network entity with the second wireless transceiver to launch the application in response to detecting the press of the button. A pen or a stylus able to control a touch-sensitive graphical user interface of a device may comprise the apparatus.

In an example an apparatus comprises at least one processing unit, at least one memory storing pairing information for at least two devices and state information, the state information indicating active devices currently connected to the apparatus, a wireless transceiver enabling a wireless connection with the at least two devices paired with the apparatus, and a button enabling launching of an application. The at least one memory stores program instructions that, when executed by the at least one processing unit, cause the apparatus to detect a press of the button, determine active devices based on the state information, and broadcast, a signal to the active devices with the wireless transceiver to launch the application in response to detecting the press of the button. A pen or a stylus able to control a touch-sensitive graphical user interface of a device may comprise the apparatus.

In an example an apparatus comprises means for processing, means for storing pairing information for at least two devices, means for enabling a wireless connection with the at least two devices paired with the apparatus and a button for enabling launching of an application. The apparatus comprises means for detecting a press of the button, means for accessing state information relating to the at least two devices, and means for sending, based on the state information, a signal to at least one of the at least two devices to launch the application in response to detecting the press of the button. A pen or a stylus able to control a touch-sensitive graphical user interface of a device may comprise the apparatus.

In an example an apparatus comprises means for processing, memory means for storing pairing information for at least two devices, a first wireless transceiver enabling a local wireless connection with the at least two devices paired with the apparatus, a second wireless transceiver enabling a connection to a network entity, and a button enabling launching of an application. The apparatus comprises means for detecting a press of the button, and means for sending a signal to the network entity with the second wireless transceiver to launch the application in response to detecting the press of the button. A pen or a stylus able to control a touch-sensitive graphical user interface of a device may comprise the apparatus.

In an example an apparatus comprises means for processing, memory means for storing pairing information for at least two devices and state information, the state information indicating active devices currently connected to the apparatus, means for enabling a wireless connection with the at least two devices paired with the apparatus, and a button enabling launching of an application. The apparatus comprises means for detecting a press of the button, means for determining active devices based on the state information, and means for broadcasting, a signal to the active devices to launch the application in response to detecting the press of the button. A pen or a stylus able to control a touch-sensitive graphical user interface of a device may comprise the apparatus.

In an example, an apparatus comprises at least one processing unit, at least one memory storing pairing information for a control apparatus and a display device, and a wireless transceiver enabling a local wireless connection with the control apparatus and the display device paired with the apparatus. The at least one memory stores program instructions that, when executed by the at least one processing unit, cause the apparatus to receive a first signal from the control apparatus, to launch an application in response to detecting the first signal, to receive a second signal from the display device, the second signal indicating that the a user started using the application with the display device, and to close the application in response to receiving the second signal.

In an example, an apparatus comprises at least one processing unit, at least one memory storing pairing information for a control apparatus and a display device, and a wireless transceiver enabling a local wireless connection with the control apparatus and the display device paired with the apparatus. The at least one memory stores program instructions that, when executed by the at least one processing unit, cause the apparatus to receive a first signal from the control apparatus, to launch an application in response to detecting the first signal, to detect that a user starts using the application with the apparatus, and to send a second signal to the display device, the second signal instructing the display device to close the application launched by the display device.

In an example, an apparatus comprises at least one a processing unit, at least one memory storing pairing information for a control apparatus and a display device, and a first wireless transceiver enabling a local wireless connection with the control apparatus and the display device paired with the apparatus, and a second wireless transceiver enabling a wireless connection with a network entity. The at least one memory stores program instructions that, when executed by the at least one processing unit, cause the apparatus to receive a first signal from the network entity, to launch an application in response to detecting the first signal, to receive a second signal from the display device, the second signal indicating that the a user started using the application with the display device, and to close the application in response to receiving the second signal.

In an example, an apparatus comprises at least one processing unit, at least one memory storing pairing information for a control apparatus and a display device, and a first wireless transceiver enabling a local wireless connection with the control apparatus and the display device paired with the apparatus, and a second wireless transceiver enabling a wireless connection with a network entity. The at least one memory stores program instructions that, when executed by at least one the processing unit, cause the apparatus to receive a first signal from the network entity, to launch an application in response to detecting the first signal, to detect that a user starts using the application with the apparatus, and to send a second signal to the display device, the second signal instructing the display device to close the application launched by the display device.

In an example, an apparatus, for example, a network server comprises at least one processing unit, at least one memory for storing state information relating to at least two devices, and a transceiver enabling a data connection with a control apparatus and the at least two devices paired with the control apparatus. The at least one memory stores program instructions that, when executed by the at least one processing unit, cause the apparatus to receive a first signal from the control apparatus, for example, a pen, the signal indicating that a button of the control apparatus has been pressed, to determine, based on the information stored in the memory, at least one device of the at least two device with which to launch an application, and to send a second signal to the determined at least one device to launch the application with the determined at least one device.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The functions described herein performed by a controller may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Although the subject matter may have been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages.

Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. An apparatus, comprising:
at least one processing unit;
at least one memory storing pairing information for at least two devices;
a first wireless transceiver enabling a local wireless connection with the at least two devices paired with the apparatus;
a button enabling launching of an application;
wherein the at least one memory stores program instructions that, when executed by the at least one processing unit, cause the apparatus to:
detect a press of the button;
access state information relating to the at least two devices; and
send, based on the state information, a signal to at least one of the at least two devices with the first wireless transceiver to launch the application in response to detecting the press of the button.

2. An apparatus according to claim 1, the at least one memory storing program instructions that, when executed by the at least one processing unit, cause the apparatus to:
receive state information relating to the at least two devices from the at least two devices with the first wireless transceiver; and
store the received state information in the memory.

3. An apparatus according to claim 1, the at least one memory storing program instructions that, when executed by the at least one processing unit, cause the apparatus to:
periodically request state information relating to the at least two devices from an entity external to the apparatus; and
store the requested state information in the memory.

4. An apparatus according to claim 1, the at least one memory storing program instructions that, when executed by the at least one processing unit, cause the apparatus to:
request state information relating to the at least two devices from an entity external to the apparatus in response to detecting the press of the button.

5. An apparatus according to claim 1, the at least one memory storing program instructions that, when executed by the at least one processing unit, cause the apparatus to:
request state information from the at least two devices in response to detecting the press of the button.

6. An apparatus according to claim 1, comprising a second wireless transceiver enabling a connection to a network entity, the at least one memory storing program instructions that, when executed by the at least one processing unit, cause the apparatus to:
receive state information relating to the at least two devices from the network entity with the second wireless transceiver; and
store the received state information in the memory.

7. An apparatus according to claim 1, comprising a second wireless transceiver enabling a connection to a network entity, the at least one memory storing program instructions that, when executed by the at least one processing unit, cause the apparatus to:
request state information relating to the at least two devices from the network entity with the second wireless transceiver in response to detecting the press of the button.

8. An apparatus according to claim 1, wherein the state information comprises at least one status parameter for each device, each status parameter having a priority value, the memory storing program instructions that, when executed by the at least one processing unit, cause the apparatus to:
select a device having a status parameter having the highest priority value in the state information; and
send the signal to the selected device.

9. An apparatus according to claim 1, wherein the state information for a device comprises information on at least one of the following:
wireless connectivity state between the apparatus and the device;
presentation mode state of the device;
screen state of the device;
battery state of the device;
screen orientation state of the device;
proximity sensor state from the device;
display size of the device;
camera detection state from the device;
screen cover state of the device;
grip detection state of the device;
proximity of the device to the apparatus;
fingerprint sensor data from a fingerprint sensor of the device; and
iris or retina scanner data of the device.

10. An apparatus according to claim 9, the at least one memory storing program instructions that, when executed by the at least one processing unit, cause the apparatus to:
determine, based on the wireless connectivity state, that the apparatus is connected only to one device; and
send the signal to the connected device.

11. An apparatus according to claim 9, the at least one memory storing program instructions that, when executed by the at least one processing unit, cause the apparatus to:
determine, based on the screen state, whether the screen of a device is off; and
send the signal to a device having the screen on.

12. An apparatus according to claim 9, the at least one memory storing program instructions that, when executed by the at least one processing unit, cause the apparatus to:
select, based on the battery state of each device, a device having the highest remaining battery charge level; and
send the signal to the selected device.

13. An apparatus according to claim 9, the at least one memory storing program instructions that, when executed by the at least one processing unit, cause the apparatus to:
select, based on the proximity sensor state of each device, a device having proximity sensor data indicating free space around the device; and
send the signal to the selected device.

14. An apparatus according to claim 9, the at least one memory storing program instructions that, when executed by the at least one processing unit, cause the apparatus to:
select, based on the display size of each device, a device having the largest display size; and
send the signal to the selected device.

15. An apparatus according to claim 9, the at least one memory storing program instructions that, when executed by the at least one processing unit, cause the apparatus to:
select, based on the camera detection state of each device, a device detecting a user of the device; and
send the signal to the selected device.

16. An apparatus according to claim 9, the at least one memory storing program instructions that, when executed by the at least one processing unit, cause the apparatus to:
select, based on the screen cover state of each device, a device not covered by a screen cover; and
send the signal to the selected device.

17. An apparatus according to claim 9, the at least one memory storing program instructions that, when executed by the at least one processing unit, cause the apparatus to:
select, based on the grip detection state of each device, a device gripped by a user; and
send the signal to the selected device.

18. An apparatus according to claim 9, the at least one memory storing program instructions that, when executed by the at least one processing unit, cause the apparatus to:
select, based on the proximity of each device to the apparatus, a device closest to the apparatus; and
send the signal to the selected device.

19. An apparatus, comprising:
at least one processing unit;
at least one memory storing pairing information for at least two devices;
a first wireless transceiver enabling a local wireless connection with the at least two devices paired with the apparatus;
a second wireless transceiver enabling a connection to a network entity;
a button enabling launching of an application;
wherein the at least one memory stores program instructions that, when executed by the at least one processing unit, cause the apparatus to:
detect a press of the button; and
send a signal to the network entity with the second wireless transceiver to launch the application in response to detecting the press of the button.

20. An apparatus, comprising:
at least one processing unit;
at least one memory storing pairing information for at least two devices and state information, the state information indicating active devices currently connected to the apparatus;
a wireless transceiver enabling a wireless connection with the at least two devices paired with the apparatus;
a button enabling launching of an application;
wherein the at least one memory stores program instructions that, when executed by the at least one processing unit, cause the apparatus to:
detect a press of the button;
determine active devices based on the state information; and
broadcast, a signal to the active devices with the wireless transceiver to launch the application in response to detecting the press of the button.
